(19) United States
(12) Patent Application Publication
(10) Pub. No.: US 2022/0288852 A1
(43) Pub. Date: Sep. 15, 2022

(54) BUILD MATERIAL LOADING

(71) Applicant: Hewlett-Packard Development Company, L.P., Spring, TX (US)

(72) Inventors: Jorge DIOSDADO BORREGO, Sant Cugat del Valles (ES); David CHANCLON FERNANDEZ, Sant Cugat del Valles (ES); Pablo Antonio MURCIEGO RODRIGUEZ, Sant Cugat del Valles (ES); Anna SUNOL JIMENEZ, Sant Cugat del Valles (ES)

(21) Appl. No.: 17/626,766

(22) PCT Filed: Sep. 27, 2019
(86) PCT No.: PCT/US19/53612

§ 371 Date: Jan. 12, 2022

(51) Int. Cl. B29C 64/321; B33Y 40/00; B22F 12/50; B22F 12/60; B22F 12/90; B29C 64/393; B33Y 50/02

(52) U.S. Cl. CPC B29C 64/321; B33Y 40/00; B22F 12/50; B22F 12/60; B22F 12/90; B29C 64/393; B33Y 50/02; B22F 2999/00

(57) ABSTRACT

According to one aspect, there is provided an apparatus for loading powder into a powder supply chamber. The apparatus comprises a powder supply module to supply powder to a supply chamber, a set of powder compaction elements and a controller. The controller is to control the powder supply module to supply powder to the supply chamber, control the compaction member to distribute and compact the supplied powder, and control the height of the supply platform and the flow of powder to the supply chamber to load the supply chamber with powder.

### BACKGROUND

There exist a multitude of kinds of three-dimensional (3D) printing techniques that allow the generation of 3D objects through selective solidification of a build material based on a 3D object model.

One technique forms successive layers of a powdered or granular build material on a build platform in a build chamber, and selectively applies a curable binder agent on regions of each layer that are to form part of the 3D object being generated. The curable binder agent has to be cured to form a sufficiently strong green part that may be removed from the build chamber, cleaned up, and then sintered in a sintering furnace to form the final 3D object.

### BRIEF DESCRIPTION

Examples will now be described, by way of non-limiting example only, with reference to the accompanying drawings, in which:

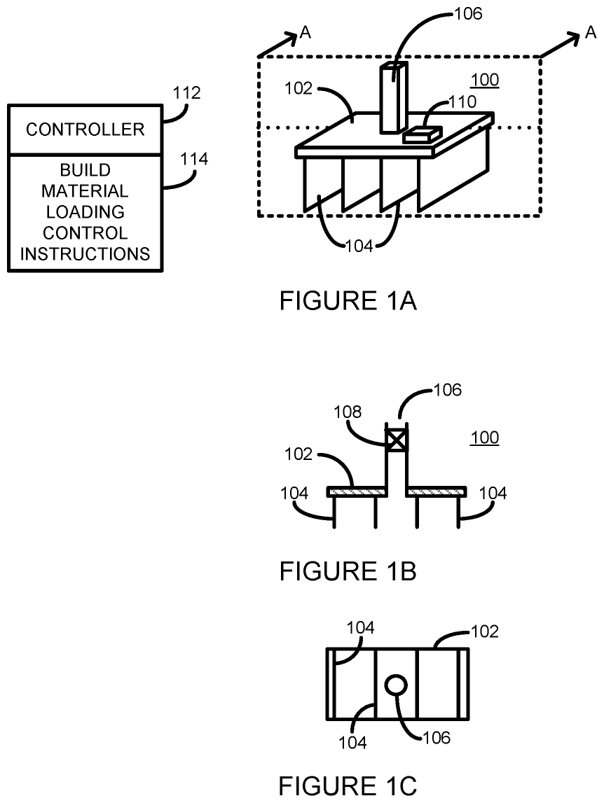

FIG. 1A to 10 illustrate a build material loading apparatus according to one example;

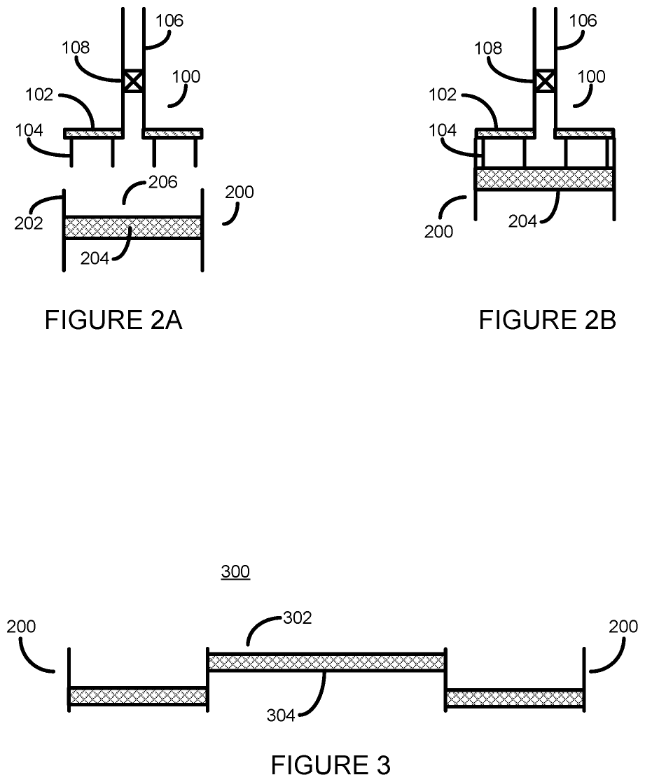

FIGS. 2A and 2B respectively illustrate a build material loading apparatus and a build material supply chamber in a disengaged and in an engaged configuration, according to one example;

FIG. 3 illustrates a build unit according to one example;

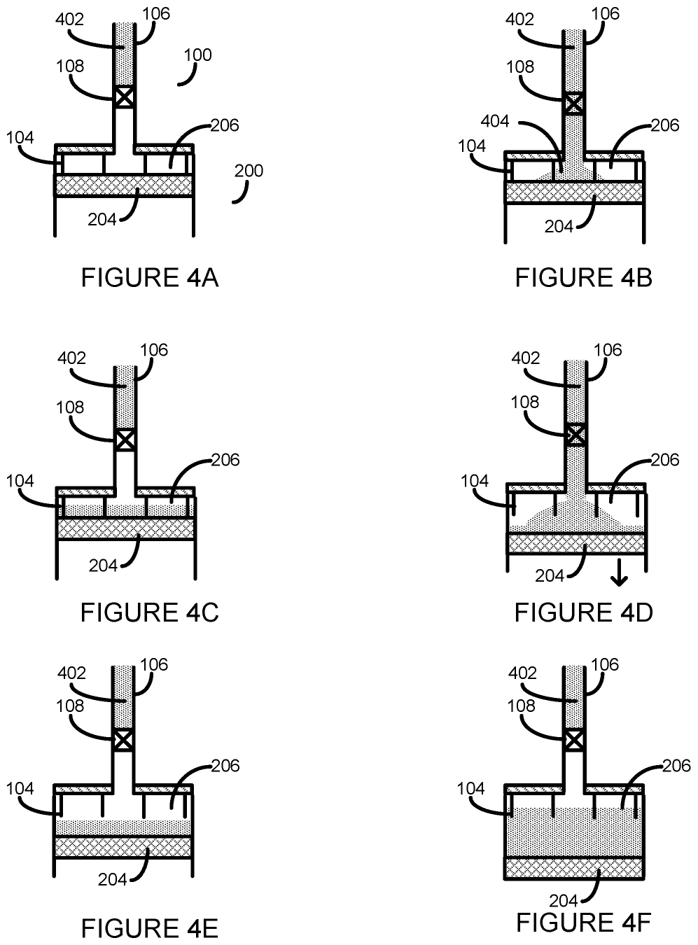

FIGS. 4A to 4F illustrate an example build material loading process;

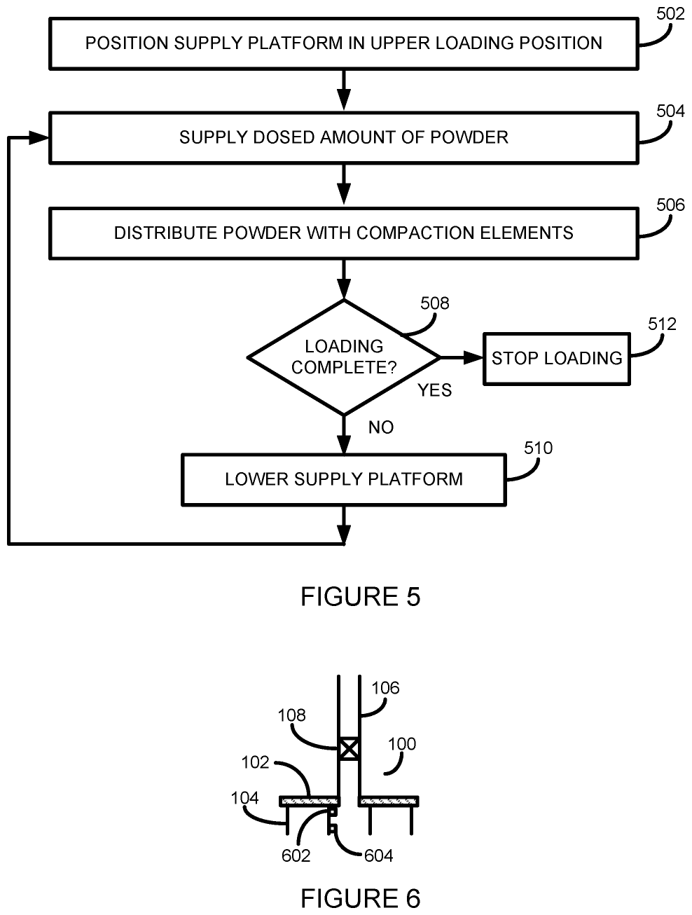

FIG. 5 is a flow diagram outlining an example method of operating the build material loading apparatus;

FIG. 6 illustrates a build material loading apparatus according to an example;

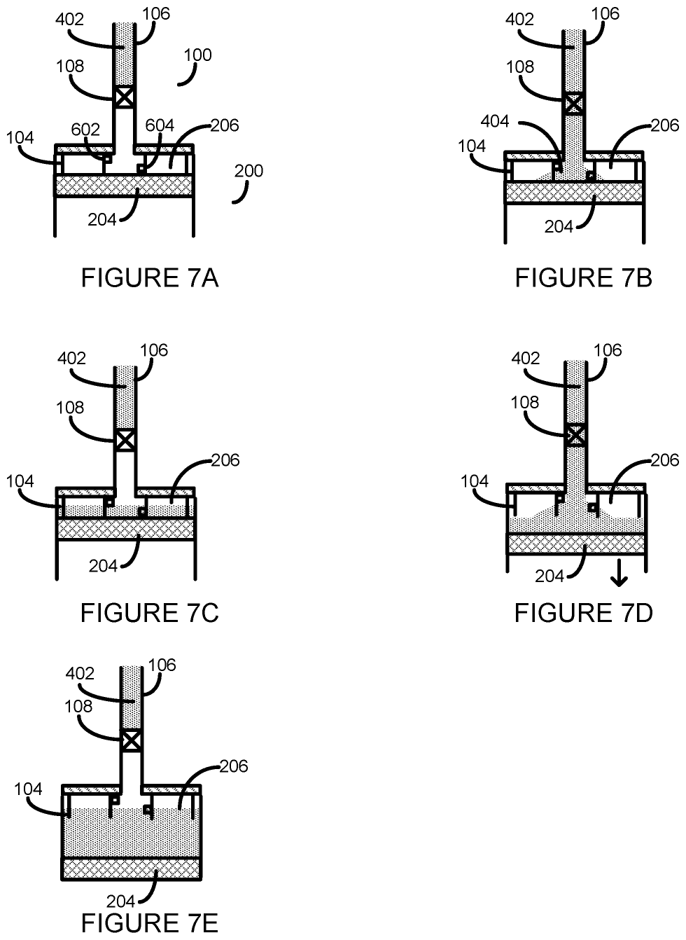

FIGS. 7A to 7E illustrate an example build material loading process;

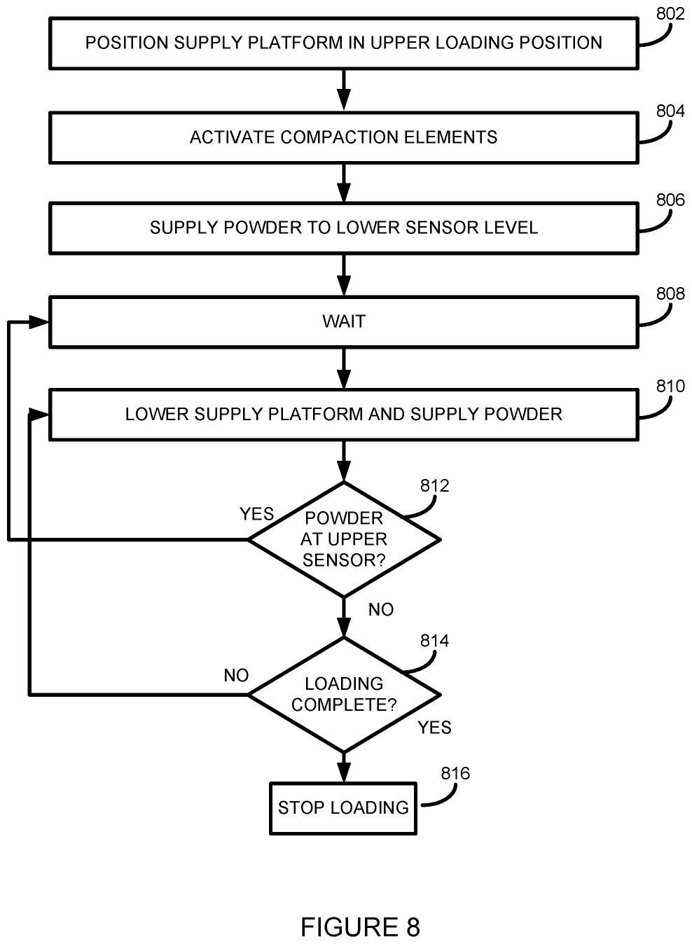

FIG. 8 is a flow diagram outlining an example method of operating the build material loading apparatus;

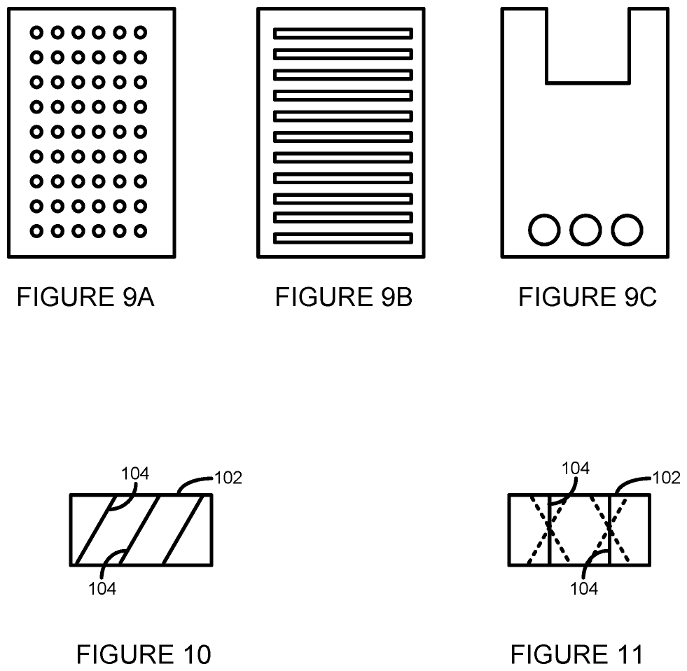

FIGS. 9A to 9C illustrate examples of compaction elements;

FIG. 10 illustrates an example arrangement of compaction elements; and

FIG. 11 illustrates an example arrangement of rotatable compaction elements.

### DETAILED DESCRIPTION

Some 3D printing system spread a volume of powdered build material (hereinafter generally referred to as powder), such as powdered metal, ceramic, or plastic powder, over a build platform (or over a previously formed layer) within a build chamber.

Some systems generate 3D objects in a build chamber that is part of a movable build unit. The build unit may include one or multiple supply chambers in which powder is loaded from a powder management station. The build unit may then be moved to a 3D printer which uses the powder in the supply chamber(s) to generate a 3D object in the build chamber by suitable additive manufacturing technique.

A supply chamber may be an open-topped cuboidal-shaped chamber having a movable supply platform as a base. Initially, the base is moved to the bottom of the supply chamber to allow powder to be loaded thereinto. To supply a volume of powder to be spread over a build platform the supply platform is raised by an appropriate amount to raise a volume of powder above the top of the supply chamber. A recoater mechanism, such as a roller or a wiper, them spreads the raised powder over the build platform to form a layer of powder thereon.

In some systems a build chamber and supply chamber may be integrated into a 3D printing system.

Typically, powder is poured into a supply chamber at a single location which leads to a generally pyramidical-shaped mound of powder being formed at the top of the supply chamber. The height of the mound will be related to factors such as the flowability and angle of repose of the powder used. A user may manually flatten the surface of supply chamber after loading, or a recoater may be also be used to automate the process.

The inventors have observed, however, that the density of powder loaded into supply chamber may vary substantially between the top and the bottom of the supply chamber. For example, it has been observed that powder at the top of the supply chamber may generally have a relatively lower density (for example, it may be airier) compared to powder at the bottom of the supply chamber which may be generally more compacted and denser. Additionally, as the supply platform is moved up to supply powder from the supply chamber, the upwards movement of the supply platform also tends to compact powder in the supply chamber, leading to initially supplied powder being less compacted than later supplied powder.

Furthermore, if the supply chamber is part of a movable build unit, it has been noticed that movement of the build unit, for example as it is moved between a powder management station and a 3D printer, may cause vibrations and/or movement in the supply chamber that can compact the powder in the supply chamber in a non-predictable manner.

The inventors have also observed that supplying powder from a supply chamber in which the powder has a non-uniform density can create issues when forming layers of powder on a build platform. For example, a volume of powder spread from the top of the supply chamber may contain less powder particles than powder spread from the bottom of the supply chamber.

These issues concern particularly powdered metal powder, but may also concern other types of powders, such as plastic and ceramic powders.

Examples are disclosed herein of an apparatus for and method of loading powder into a supply chamber such that the powder has a more uniform density within the supply chamber.

Referring now to FIG. 1A, there is shown a simplified isometric view of a powder loading apparatus 100 for loading powder into a supply chamber according to one example. FIG. 1B shows a cross-section view of the apparatus 100 taken through the plane A-A, and FIG. 10 shows a corresponding bottom view of the apparatus 100.

The apparatus 100 comprises a base 102 to which are connected a number of compaction elements 104. Each compaction element 104 may, in one example, take the form of a thin sheet of substantially rigid material, such as aluminum, steel, or plastic. In the example shown, each compaction element 104 is mounted on the underside of the base 102 and extends vertically below the base. In the example shown, the compaction elements 104 are aligned perpendicular to the longitudinal axis of the base 100. Four compaction elements 104 are shown in FIG. 1A, although in other examples other numbers of compaction elements may be provided. In the example shown, the compaction elements 104 are spaced equidistantly although in other examples other spacings may be used. In the example shown, each compaction element 104 spans the whole width of the base 102, although in other examples the compaction elements 104 may span less than the whole width of the base 102. In one example, the base of each compaction element may be interconnected using a rigid connector, to increase the rigidity of each compaction element 104.

Coupled to the top of the base 102 is a feed channel 106 which is in fluid communication with a powder store (not shown), such as a hopper positioned above the apparatus 100. The feed channel 106 passes through the base 102 to allow powder to be supplied, for example under gravity, to a powder supply chamber in which the compaction elements 104 are inserted. In the feed channel 106 is provided a controllable valve 108 to, under control of a controller 112, to stop, start, or otherwise modulate the flow of powder through the feed channel 106.

A mechanical actuator 110 is provided on the base 102 to move the compaction elements 104 to cause, under control of the controller 112, the compaction elements 104 to distribute and compact powder within which they are in contact. In the example shown, the actuator 110 is a vibrator that imparts vibrations to the base 102 and hence imparts vibrations to each of the compaction elements 104 to at least partially fluidise the powder in proximity to the compaction elements 104. The fluidization of the powder causes the powder to, under gravity, compact and distribute itself substantially evenly and to have a substantially level upper surface. In other examples, an actuator could be coupled to each of the compaction elements 104.

The controller 112 comprises a memory in which are stored powder loading control instructions 114 which, when executed by the controller, control the apparatus 100 to operate as described herein.

The apparatus 100 is designed to engage with a supply chamber, as illustrated in FIG. 2. FIG. 2A shows a side cross-sectional view of the apparatus 100 positioned in a disengaged position above a powder supply unit 200. The supply unit 200 is formed of sidewalls 202 and a vertically moveable supply platform 204 that forms the base of a supply chamber 206. In the disengaged position, the distal ends of the compaction elements 104 are positioned outside of the supply chamber 206.

FIG. 2B shows a side view of the apparatus 100 in an engaged position with supply unit 200 such that the base 102 of the apparatus 100 is in contact with, or is within a predetermined distance of, the top of the supply unit 200 and in which the distal ends of the compaction elements 104 are positioned within the supply chamber 206. Prior to the engagement, the supply platform 204 of the build unit is positioned to an initial loading position which is below the top of the supply chamber 206 by a distance the same as or slightly greater than the height of the compaction elements 104. In this way, the compaction elements 104 may be in contact with, or may be above (for example 0.5 cm above, 1 cm above, 2 cm above, 5 cm above, 10 above), the supply platform 204. When in the engagement position electrical contact may be made between the apparatus 100 and the supply unit 200 to enable the controller 112 to control the position of the supply platform 204.

In one example the apparatus 100 may be movable downwards towards the supply chamber 206. In another example the supply unit 200 may be moveable upwards towards the apparatus 100. In one example the apparatus 100 may comprise an interface (not shown) to receive a supply unit 200 and may comprise a suitable movement mechanism to move the apparatus 100 and supply unit 200 relative to one another into the engagement position. In one example, the movement mechanism may comprise a lift mechanism to, for example, lift a supply chamber into an engagement position with the loading apparatus 100. In the example shown, when in the engaged position, a substantially hermetic seal is formed between the base 102 and the supply chamber 206. Forming a good seal helps prevent powder from becoming airborne during a powder loading operation, which helps facilitate powder loading.

In one example, the supply unit 200 may be part of a build unit 300, as illustrated in FIG. 3. In this example, a pair of supply units 200 may be provided on either side of a build chamber 302. The build chamber 304 comprises a vertically moveable build platform 304 on which powder supplied by at least one of the supply units 200 may be spread over the build platform 304 by a suitable layer forming module to form a layer of powder to be processed by a 3D printing system.

Operation of the apparatus 100 will now be described with reference to FIGS. 4A to 4E and with additional reference to the flow diagram of FIG. 5.

Initially the apparatus 100 and the supply unit 200 are positioned in an engagement position, as illustrated in FIG. 4A. This may be achieved, for example, through an automated moving of either or both of the apparatus 100 and the supply unit 200, for example under control of the controller 112 or through any other suitable mechanism. As shown in FIG. 4A a supply of powder 402 is connected to the feed channel 106 from a powder store (not shown).

At block 502, the controller 112 controls the supply platform 204 to move into an upper loading position. In one example, this may be performed by an operator prior to the supply unit 200 being engaged with the apparatus 100, in which case block 502 may be omitted from some examples. The upper loading position is a position at which the supply platform 204 is in contact, or is in close proximity (for example less than 0.5 cm, or less than 1 cm, or less than 2 cm, or less than 5 cm) away from the base of the compaction elements 104 when the supply platform 200 and the apparatus 100 are in the engaged position.

At block 504, the controller 112 controls the valve 108 to supply an amount of powder 402 to the supply chamber 206, as illustrated in FIG. 4B. The amount of powder 402 supplied may, in one example, be a predetermined volume of powder, that may be based on the size of the supply chamber 206. In one example the amount of powder supplied may be in the region of about 1000 cm³ to 3000 cm³ of powder, although in other examples other amounts may be supplied. In one example the controller 112 may open the valve 108 for an amount of time to allow the predetermined amount of powder to flow into the supply chamber 206. In another example, a dosing or measurement mechanism may be used to allow the controller 112 to cause the predetermined amount of powder to flow into the supply chamber.

At block 506, the controller 112 controls the actuator 110 to move the compaction elements 104 to distribute the supplied powder along the length and width of the supply chamber 206. In one example, the actuator is a vibrator, such as an eccentric mass rotated by a motor, that causes vibrations to be transmitted to the compaction elements 104. In one example, the vibrations may have a frequency of between about 20 and 100 Hz, that cause the compaction elements 104 to move, for example by fluidizing, the supplied powder thereby distributing it within the supply chamber 206 such that the supplied powder forms a substantially flat volume of powder that has a substantially uniform density. By substantially uniform density is meant a density that varies by less than about 20%, or less than about 10%, or less than about 5%, from the top to the bottom of the supply chamber. In one example, the controller 112 controls the actuator 110 to move the compaction elements 104 for a predetermined amount of time, such as for 1 second, for 2 seconds, for 5 seconds, for 10 seconds, for 30 seconds, for 60 seconds, for 120 seconds, or for 240 seconds.

At block 508, the controller 112 determines whether powder loading has completed. In one example, the controller 112 may make this determination by determining when the supply platform has been moved to a predetermined position, such as it's lowest or other suitable position. In another example, the controller 112 may make this determination by determining when a predetermined volume of powder has been supplied to the supply chamber 206. If the controller 112 determines that the loading process has completed, the loading process is stopped (block 512). Otherwise, the controller 112 controls the supply platform to lower (block 510) by a predetermined height, and the process repeats. In one example, the predetermined height is about 2 cm, or about 5 cm, or about 10 cm. As illustrated in FIG. 4D, the controller 112 again controls the valve 108 to allow another predetermined amount of powder to flow into the supply chamber 206, and controls the compaction elements 104 to distribute the newly supplied powder on top of the previously distributed and compacted powder, as illustrated in FIG. 4E.

At the end of the loading process the supply platform 204 is positioned in its lowest position, and a substantially evenly compacted volume of powder is provided in the supply chamber 206, as illustrated in FIG. 4F. By substantially even density is meant a density that varies by less than about 20%, or less than about 10%, or less than about 5%, from the top to the bottom of the supply chamber.

The loading process described above with reference to FIG. 5 enables a batch loading process, where the powder is supplied to the supply chamber and the compaction elements 104 distribute and compact the powder in a series of batches.

In a further example, as shown in FIG. 6, a first powder level sensor 602 is provided at a first position on one of the compaction elements 104, and a second powder level sensor 604 is provided at a second lower position below the first position height on either the same or on a different one of the compaction elements. In one example, the powder level sensors are capacitive sensors that enable the controller 112 to detect when a powder is in contact with the sensors. In other examples other types of sensors, such as inductive sensors could be used.

Operation of the apparatus 100 with powder level sensors 602 and 604 will now be described with reference to FIGS. 7A to 7E and with additional reference to the flow diagram of FIG. 8.

Initially the apparatus 100 and the supply unit 200 are positioned in an engagement position, as illustrated in FIG. 7A. This may be achieved, for example, through an automated moving of either or both or the apparatus 100 and the supply unit 200, for example under control of the controller 112 or through any other suitable mechanism. As shown in FIG. 7A a supply of powder 402 is connected to the feed channel 106 from a powder store (not shown).

At block 802, the controller 112 controls the supply platform 204 to move into the upper loading position. In one example, this may be performed by an operator prior to the supply unit 200 being engaged with the apparatus 100, in which case block 502 may be omitted from some examples.

At block 804, the controller 112 controls the actuator 110 to activate the compaction elements 104, for example by vibrating them. At block 806, the controller 112 controls the valve 108 to open and allow powder 402 to flow into the supply chamber 206 until the lower powder level sensor 604 detects the presence of powder, as illustrated in FIG. 7B. At block 808 the controller 112 waits for a predetermined time, such as 10 seconds, 30 seconds, 60 seconds, 120 seconds, or 240 seconds, whilst the powder supplied to the supply chamber 206 is distributed and compacted by the compaction elements 204, as illustrated in FIG. 7C.

At block 810, the controller 112 controls the supply platform 204 actuator to start moving downwards at a predetermined speed and at the same time controls the valve 108 to supply powder at a predetermined flow rate. The predetermined speed and powder flow rate may be chosen such that powder supplied to the supply chamber is sufficiently distributed and compacted during the continuous powder supply and supply platform lowering operations.

At block 812, the controller 112 determines whether there is powder detected at the upper sensor 602. If so, the controller 112 causes the process to suspend the supply of further powder whilst the compaction elements 104 continue to distribute and compact the supplied powder.

At block 814, the controller 112 determines whether powder loading has completed, as illustrated in FIG. 7E. In one example, the controller 112 may make this determination by determining when the supply platform has been moved to its lowest position. In another example, the controller 112 may make this determination by determining when a predetermined volume of powder has been supplied to the supply chamber 206. If the controller 112 determines that the loading process has completed, the loading process is stopped (block 816). Otherwise, the controller 112 controls the supply platform to continue to be lowered at the predetermined speed whilst supplying powder to the supply chamber at the predetermined rate.

At the end of the loading process the supply platform 204 is positioned in its lowest position, and a substantially evenly compacted volume of powder is provided in the supply chamber 206, as illustrated in FIG. 4F. The loading process described above with reference to FIG. 8 enables a continuous loading process, where the powder is supplied to the supply chamber and the compaction elements 104 distribute and compact the powder in a generally continuous process.

In one example, the compaction elements 104 may have a set of apertures therein, as illustrated in FIG. 9A and FIG. 9B. In FIG. 9A each compaction element 104 has a series of apertures arranged in a grid configuration. In FIG. 9B each compaction element has a series of slots arranged in a vertical configuration. In other examples other configurations of apertures and/or slots may be provided. The presence of the apertures and/or slots enables powder to flow between compaction elements, which has been shown to improve the speed at which the distribution and compaction of powder occurs in the supply chamber. In FIG. 9C, a further example of a compaction element 104 is shown that has a solid portion in the middle of the element, and a set of apertures in the lower portion of the element. With this arrangement, the middle section is to compact the powder, whilst the lower portion is to distribute the powder. It will be appreciated that other designs of compaction element could be used.

In a further example, as illustrated in FIG. 10, the compaction elements 104 may be arranged oblique to the longitudinal axis of the of the base 102.

In a yet further example, as illustrated in FIG. 11, the compaction elements 104 may be articulated at the base 102 to enable each of the compaction elements 104 to be rotated around the articulation. For example, the actuator 110 may be a motor coupled to each compaction element to, under control of the controller 112, rotate each compaction about its rotation axis. In this example, it is the rotation of the compaction elements that causes the distribution and compaction of powder within the supply chamber. In a yet further example, a vibrator may be provided to impart vibrations to the compaction elements 104 as they are rotated to further enhance distribution and compaction of powder in the supply chamber.

In one example, the powder loading apparatus 100 may be part of a powder management station. In another example, the powder loading apparatus 100 may be part of a 3D printer.

It will be appreciated that example described herein can be realized in the form of hardware, software or a combination of hardware and software. Some examples provide a program comprising code for implementing a system or method as claimed in any preceding claim and a machine-readable storage storing such a program.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. Apparatus for loading powder into a powder supply chamber, the apparatus comprising:
a powder supply module to supply powder to a supply chamber;
a set of powder compaction elements;
a controller to:
control the powder supply module to supply powder to the supply chamber;
control the compaction member to distribute and compact the supplied powder; and
control the height of the supply platform and the flow of powder to the supply chamber to load the supply chamber with powder.

2. The apparatus of claim 1, further including a mechanism to move the apparatus and the supply chamber relative to one another to move between a first engaged position in which the distal ends of compaction elements are positioned within the supply chamber, and a second disengaged position wherein the distal ends of the compaction elements are positioned outside of the supply chamber.

3. The apparatus of claim 1, further including a base to which are connected the powder compaction elements and through which is provided a teed channel to supply powder from the powder supply module to the supply chamber.

4. The apparatus of claim 3, further including an actuator to move the compaction elements to distribute and compact powder.

5. The apparatus of claim 3, wherein the base seals against the supply chamber to substantially hermetically seal the supply chamber when in the engaged position.

6. The apparatus of claim 4, wherein the controller is to:
control a valve in the feed channel to supply a dosed amount of powder to the supply chamber;
control the actuator to move the compaction elements to distribute and compact the supplied powder;
control the supply platform to lower by a predetermined height; and
repeat the process until the controller determines that the supply platform is at a predetermined position.

7. The apparatus of claim 4, further including a first powder sensor at a first position on a compaction element, and a second powder sensor at a second lower position on a compaction element, and wherein the controller is to:
activate the actuator to move the compaction elements;
supply a first amount of powder to the supply platform;
wait for a predetermined length of time; and
lower the supply platform at a predetermined speed whilst supplying powder to the supply chamber at a predetermined rate until the supply platform reaches a predetermined position.

8. The apparatus of claim 1, wherein the compaction elements are one of: substantially solid elements; and include a set of apertures.

9. The apparatus of claim 1, wherein the actuator is to one of: vibrate the compaction elements; and rotate the compaction elements.

10. A method of loading build material into a supply chamber comprising:
moving a powder loading apparatus and a powder supply chamber into an engagement position;
position a supply platform at an initial loading position;
supplying powder through a feed channel into the supply chamber;
moving a set of compaction elements to distribute and compact build material in proximity to the compaction elements.

11. The method of claim 10, further including, lowering the supply platform by a predetermined distance, supplying a further quantity of build material to the supply chamber, and moving the set of compaction elements to distribute and compact the further quantity of build material on top of the previously distributed and compacted build material.

12. The method of claim 10, wherein moving the compaction elements includes one of: vibrating the compaction elements; and rotating the compaction elements.

13. The method of claim 12, further including, lowering the supply platform at a predetermined speed and supplying build material to the supply chamber at a predetermined flow rate whilst continuing to move the compaction elements.

14. The method of claim 10, further including stopping the supply of build material and the movement of the compaction elements when the supply platform reaches a predetermined position.

15. A computer-readable medium on which are encoded computer executable instructions that, when executed by a processor cause the processor to:
supply powder through a feed channel into a supply chamber;
move a set of compaction elements to distribute and compact build material in proximity to the compaction elements;
lower a supply platform; and
supply further powder to the supply chamber.
